(19) United States
(12) Patent Application Publication
(10) Pub. No.: US 2004/0153748 A1
(43) Pub. Date: Aug. 5, 2004

(54) Method for configuring a data processing system for fault tolerance

(76) Inventors: Alfio Fabrizi, Fonte Nuova (IT); Angelo Littera, Rome (IT)

Correspondence Address: IBM CORPORATION, IPLAW IQ0A/40-3, 1701 NORTH STREET, ENDICOTT, NY, 13760, US

(21) Appl. No.: 10/602,901

(22) Filed: Jun. 24, 2003

(30) Foreign Application Priority Data
Dec. 19, 2002 (EP) 02368142.2

(51) Int. Cl. H04L 1/22

(52) U.S. Cl. 714/10

(57) ABSTRACT

A technique for configuring a data processing system for high availability. A set of rules for high availability is defined. A set of target parameters indicative of a target configuration of the data processing system which is highly available, is also defined. A set of existing parameters indicative of a current configuration of the data processing system is automatically collected from the data processing system. The rules with the target parameters are automatically applied to the existing parameters to identify actions to reconfigure the data processing system for high availability. Some of the target parameters identify resources of the data processing system intended to be highly available. Some of the identified actions are automatically implemented.

### TECHNICAL FIELD

The present invention relates generally to data processing systems and more particularly to a method of configuring the data processing system for fault tolerance.

### BACKGROUND ART

Data processing systems are widely used today. Fault tolerance is a major issue not only in fields where safety is at stake but also in fields where the data and the data processing systems are crucial to business operation. Fault-tolerant data processing systems are sometimes referred to as a Highly-Available or High-Availability (“HA”) data processing systems. Such systems preserve data and maintain computer processing and communication capability despite failure of one or more components or resources.

Data processing systems normally include many components or resources, typically arranged in a data communication network configuration. Data processing system components may include server machines such as network servers, file servers and production servers, and network terminals such as personal computers and/or workstations. Data processing system components may also include mass storage devices, printers, application software, infrastructure software, software drivers, user libraries of software objects and data archives.

A known technique for setting up an HA data processing environment provides redundancy in key data processing system resources. For example, a “cluster configuration” of servers provides redundancy of servers. In this configuration, resources (e.g., the central processing unit, the mass storage devices and the like) associated with a given node of the network (e.g., a production server machine) are linked to each other. Consequently, they can be mirrored to a back-up or mirror node to ensure redundancy for high availability. In the event of a failure of the main node, the back-up node is capable of taking over some or all of the work of the failed node.

In many cases, an existing data processing system needs to be configured for HA. For example, a company relying on an existing data processing system may desire to improve the reliability thereof by implementing an HA data processing environment. Implementing an HA data processing environment in an existing data processing system is a challenging task. Key elements for implementing an HA data processing environment are the analysis and assessment of the existing data processing system, and their configuration to achieve the desired reliability and fault tolerance. Typically, highly skilled people are required to analyse the existing data processing system and identify the customer's needs in terms of reliability and fault tolerance. The customer's needs are determined by personally interviewing the customer (i.e., the owner of the data processing system), and based on the expertise of the systems analyst. After determining the customer's needs, the systems analyst generates a project report in which the actions needed to set up an HA data processing environment with the desired features are listed. The quality of the analysis performed by the systems analysts is crucial to the quality of the HA data processing environment.

The foregoing process of defining the actions needed for configuring the existing data processing system for HA is not efficient in many respects. It relies heavily on the professional skills of a handful of extremely specialised systems analysts. These skills are rare and expensive. Also, any human activity is prone to errors. For example, the analysis of the existing data processing system may be incomplete or some key elements may pass unobserved or be underestimated. Some critical issues may not be discussed with the customer, the customer may not be (and normally is not) able to provide all the information requested by the systems analyst, or the customer's answers may not be deeply understood by the systems analyst. Furthermore, the analysis of the existing data processing system is time consuming and costly. An HA data processing environment developed on the basis of an unsatisfactory analysis of the existing data processing system may cause serious problems during the data processing system operation. These problems would be encountered when HA functionalities are relied upon, e.g. in case of system crashes.

Accordingly, an object of the present invention is to automate the process of configuring a data processing system for HA.

Another object of the present invention is to reduce errors in the process of defining the HA data processing environment for an existing data processing system.

Still another object of the present invention is to expedite the process of defining an HA environment for an existing data processing system, and during this process not impair the functionality of the data processing system.

### SUMMARY OF THE INVENTION

The invention resides in a technique for configuring a data processing system for high availability. A set of rules for high availability is defined. A set of target parameters indicative of a target configuration of the data processing system which is highly available, is also defined. A set of existing parameters indicative of a current configuration of the data processing system is automatically collected from the data processing system. The rules with the target parameters are automatically applied to the existing parameters to identify actions to reconfigure the data processing system for high availability.

According to one feature of the present invention, some of the target parameters identify resources of the data processing system intended to be highly available.

According to another feature of the present invention, some of the identified actions are automatically implemented.

### BRIEF DESCRIPTION OF THE DRAWINGS

FIG. 1 is a schematic diagram of computers and a computer network in which the present invention can be implemented.

FIG. 2 is a block diagram of a server computer of the computer network of FIG. 1.

FIG. 3 schematically illustrates the content of a working memory of the server computer of FIG. 2, and a client computer of the computer network of FIG. 1, during the execution of respective parts of a client-server software tool implementing the present invention.

FIGS. 4A, 4B, 4C and 4D form a flowchart of a method according to the present invention for configuring a server computer for high availability.

FIG. 5 illustrates a server parameter database used in the method of FIGS. 4A, 4B, 4C and 4D.

FIG. 6 illustrates a menu page displayed to a user of the client computer of FIG. 2, when defining target parameters of the high availability environment.

FIG. 7 schematically illustrates a process of applying an automatic analysis rule in the method of FIGS. 4A, 4B, 4C and 4D.

FIG. 8 depicts a project database generated by the method of FIGS. 4A, 4B, 4C and 4D.

FIG. 9 depicts another project database generated by the method of FIGS. 4A, 4B, 4C and 4D.

### DETAILED DESCRIPTION OF THE PREFERRED EMBODIMENT

With reference to the drawings, and particularly to FIG. 1, an exemplary data processing system 100 is schematically shown. The data processing system 100 can be part of the production environment of an enterprise, such as a bank, a public administration, an Internet service provider or the like. The data processing system 100 comprises a plurality of components 105a, 105b, 105c, . . . , 105n, for example personal computers (PCs), workstations, printers, mass-storage devices and the like, arranged in a computer network configuration. The computer network, depicted only schematically in FIG. 1 and denoted therein by reference numeral 110, is for example a Local Area Network (LAN) such as an Ethernet network or an SNA (System Network Architecture) network. However, the present invention is not limited to any specific computer network configuration.

The data processing system 100 includes at least one production server computer such as data processing system component 105a; in the context of the present description. The production server computer 105a may also have other functions, such as functions of network server machine, managing the data traffic over the network 110, file server, database server and print server. By way of example and not limitation, in the following it will be assumed that the production server computer 105a is a machine of the family iSeries Servers produced by IBM Corporation, equipped with the OS/400 operating system. The present invention can be generally applied to any data processing system and, more specifically, to any computer network, irrespective of the server machine type, the operating system, the network architecture. Examples of different operating systems are Windows NT, Windows 2000, OS/2, Linux.

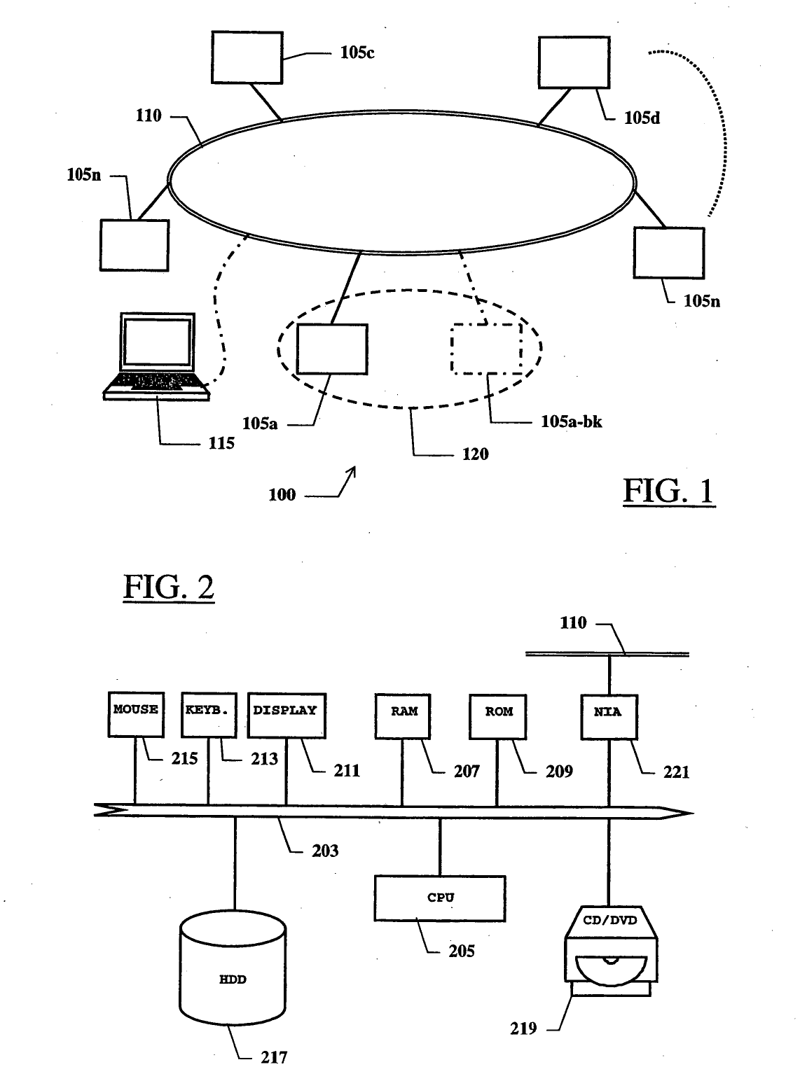

As schematically shown in FIG. 2, a generic computer of the data processing system 100, for example the production server computer 105a, comprises several functional units connected in parallel to a data communication bus 203, for example of the PCI type. In particular, a Central Processing Unit (CPU) 205, typically comprising a microprocessor, e.g. a RISC processor, controls the operation of the production server computer 105a, a working memory 207, typically a RAM (Random Access Memory) is directly exploited by the CPU 205 for the execution of programs and for temporary storage of data, and a Read Only Memory (ROM) 209 stores a basic program for the bootstrap of the production server computer 105a. The production server computer 105a comprises several peripheral units, connected to the bus 203 by means of respective interfaces. Particularly, peripheral units that allow the interaction with a human user are provided, such as a display device 211 (for example a CRT, an LCD or a plasma monitor), a keyboard 213 and a pointing device 215 (for example a mouse or a touch pad). The production server computer 105a also includes peripheral units for local mass-storage of programs (operating system, application programs, operating system libraries, user libraries) and data, such as one or more magnetic Hard-Disk Drivers (HDD), globally indicated as 217, driving magnetic hard disks, and a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards, a magnetic tape mass-storage storage unit and the like. The production server computer 105a is further equipped with a Network Interface Adapter (NIA) card 221 for the connection to the computer network 110. Any other computer/workstation 105b, . . . , 105n in the data processing system 100 has a structure generally similar to that depicted in FIG. 2, possibly properly scaled depending on the machine computing performance.

Assume that the owner of the data processing system 100 desires to set up an HA data processing environment, so as to render the data processing system 100 more reliable and fault tolerant. For simplicity of description, in the following it will be assumed that fault tolerance is desired in respect of at least those tasks, critical for the activity or business of the data processing system owner, that are managed by the production server computer 105a. Examples of the tasks that can be managed by the production server computer 105a are accounting tasks, business management tasks, manufacturing process control tasks, workflow management tasks, e-commerce tasks, electronic messaging tasks, web hosting tasks. One or more of these tasks are performed by the production server computer by means of dedicated application software. Typically, these application software's have a client-server architecture, with a server software component installed and running in the production server computer 105a, while a plurality of client software components are installed and run in one or more client computers of the data processing system 100.

From a practical viewpoint, implementing an HA data processing environment in the existing data processing system 100 means grouping those resources of the data processing system 100 that are critical for the activities or business of the data processing system owner, and mirroring the resource groups, including for example an application program, the libraries and the data structures it relies upon. For example, in order to set up the desired HA data processing environment, at least one mirror or back-up production server 105a-bk (FIG. 1) will have to be set up that is capable of hosting a copy or mirror resource group, so as to be able to take over the role of production server whenever the production server computer 105a, for any reason, is not able to perform the intended tasks. Depending on the specific cases, the machine intended to become the back-up production server 105a-bk may be chosen among the already existing machines 105b, . . . , 105n of the data processing system 100, if one of the existing machines is found to be structurally adequate to perform the job of production server, or a new machine with suitable features may be added to the data processing system 100, by connecting it to the data communication network 110. The production server computer 105a and the back-up production server computer 105a-bk thus form an HA cluster 120 in the data processing system 100.

The definition of the proper HA data processing environment for the data processing system 100 involves analysing and configuring the existing data processing system 100. According to an embodiment of the present invention, a method of analyzing and configuring the data processing system 100 for defining and setting up of an HA data processing environment is carried on automatically or at least partially automatically, by means of an HA definition software tool. In particular, according to an embodiment of the present invention, the HA definition software tool has a client-server architecture. A server software component of the HA definition software tool, once installed, runs under the control of the production server computer 105a in the data processing system 100 for which an HA data processing environment needs to be defined; a client software component of the HA definition software tool, once installed, runs under the control of a client computer in the data processing system 100; the client computer can be any one of the personal computers or workstations of the data processing system 100 or, preferably, a PC 115, e.g. a portable PC exploited by a user (typically, a technician of a company providing services in the field of information technology) in charge of analyzing the existing data processing system for defining and setting up the HA data processing environment, that is purposely connected to the data communication network 110 and behaves as a client computer in respect of the production server computer 105a. The client computer 115 has generally the structure shown in FIG. 2.

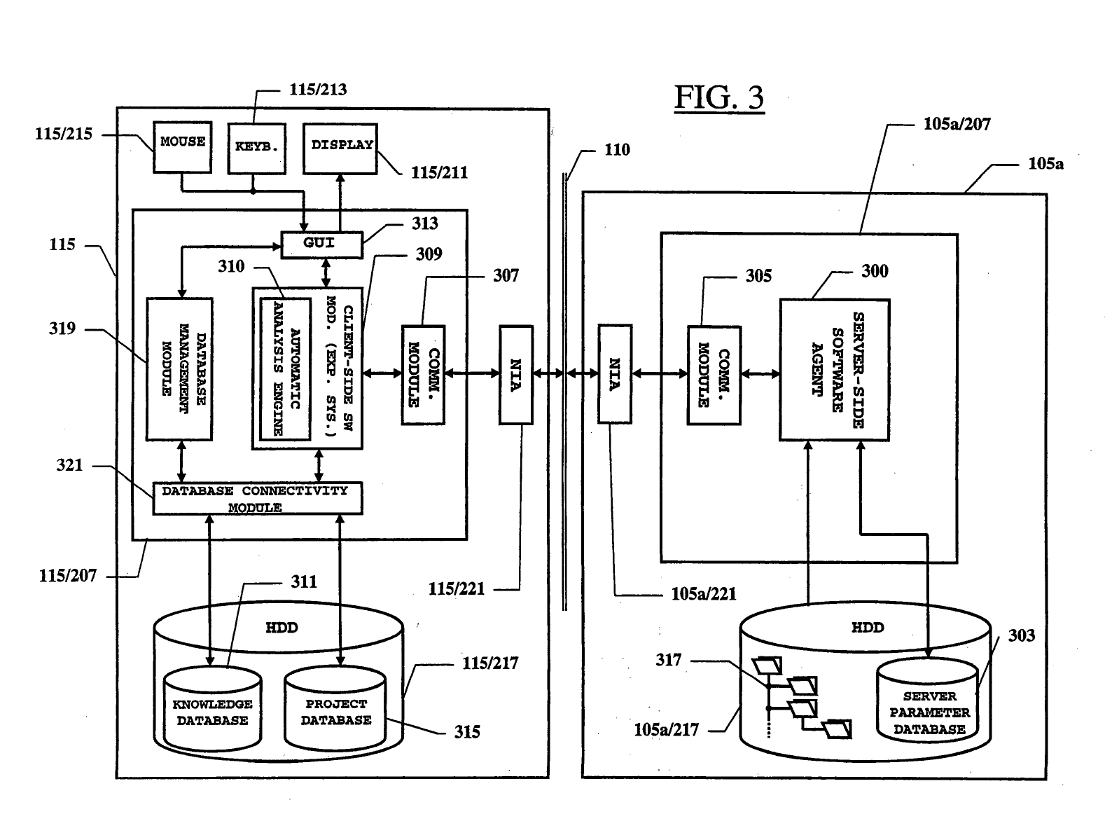

FIG. 3 schematically shows a partial content of a working memory 105a/207 of the production server computer 105a, and a partial content of a working memory 115/207 of the client computer 115, when the server software component and the client software component of the HA definition software tool are running on the production server computer 105a and the client computer 115, respectively. Considering the production server computer 105a, the server software component includes a server-side software agent 300 adapted to perform an automatic inspection of the data processing system 100 and to collect information relevant to the definition of the HA data processing environment for the data processing system 100. In particular, in an embodiment of the present invention, the server-side software agent 300 performs an automatic inspection of a file system of the production server computer 105a, stored on the hard disk(s) 105a/217 thereof, identifies and collects production server computer parameters that are relevant for the definition and setting up of the HA data processing environment. In general, the type of parameters that are automatically collected by the server-side software agent depends on the data processing system for which the HA data processing environment needs to be defined, for example on the type of production server computer and on its operating system; the type of parameters to be automatically collected is for example embedded in the code of the server-side software agent.

The server-side software agent 300 stores the collected production server computer parameters in a production server computer parameter database 303; the production server computer parameter database 303 is preferably stored in the hard disk(s) 105a/217 of the production server computer 105a. A communication module 305 allows the server-side software agent 300 communicating with the client software component over the data communication network 110 (through the NIA card 105a/221 of the production server computer 105a). In the client computer 115, the client software component includes a communication module 307, allowing the client software component communicating with the server-side software agent 300 (through the NIA card 115/221 installed in the client computer 115), an expert-system client-side software module 309, operating on the basis of a knowledge database 311, and a Graphical User Interface (GUI) module 313, allowing a user to interact with the expert-system client-side software module 309 through the display device 115/211 and the input devices 115/213′ (keyboard) and 115/215 (mouse) of the client computer 115. As will be described in greater detail later on, the knowledge database 311 includes a database of standard questions to be answered for defining targets of the HA data processing environment, a database of automatic analysis rules, exploited by a rule-based automatic analysis engine 310 of the client-side software module 309 for conducting an automatic rule-based analysis of the parameters available for the definition of the HA data processing environment, a database of additional questions that, as a result of the automatic rule-based analysis, may require an answer for obtaining additional parameters relevant to the definition and setting up of the HA data processing environment, and a database of recommendations/suggestions and of prescriptions of corrective actions to be performed on the data processing system 100 for the definition and setting up of the HA data processing environment. In the context of the present description, by additional questions there is intended one or more additional questions directed to obtaining, from the user and/or the owner of the data processing system 100, additional parameters relevant for the definition of the desired HA data processing environment, such additional parameters not being automatically retrievable from the data processing system by automatic inspection thereof, and such additional questions arising once from the analysis of the data processing system parameters once the targets of the HA data processing environment have been defined. Also, in the context of the present description, by configuring actions there is intended one or more corrective actions to which the existing data processing system 100 needs to be subjected in order to prepare and adapt it to the setting up of the desired HA data processing environment.

In operation, the expert-system client-side software module 309 generates a project database 315. The knowledge database 311 and the project database 315 are for example stored on the hard disk 115/217 of the client computer 115. A database connectivity module 321, for example based on JAVA, allows the expert-system client-side software module 309 interacting with the knowledge database 311 and the project database 315. A knowledge database management software module 319, interacting with the GUI module 313 and the database connectivity module 321, allows the user to manage (e.g., update) the knowledge database 311. Exploiting the knowledge database management software module 319, the user can update the knowledge database 311, e.g. for modifying, adding, deleting standard questions, rules for the automatic rule-based analysis, and additional questions or prescriptions of corrective actions. By way of example, the communication modules 305 and 307 allows communication between the production server computer 105a and the client computer 115 on the basis of the TCP/IP communication protocol, and the database connectivity module 319 is a Java database connectivity module.

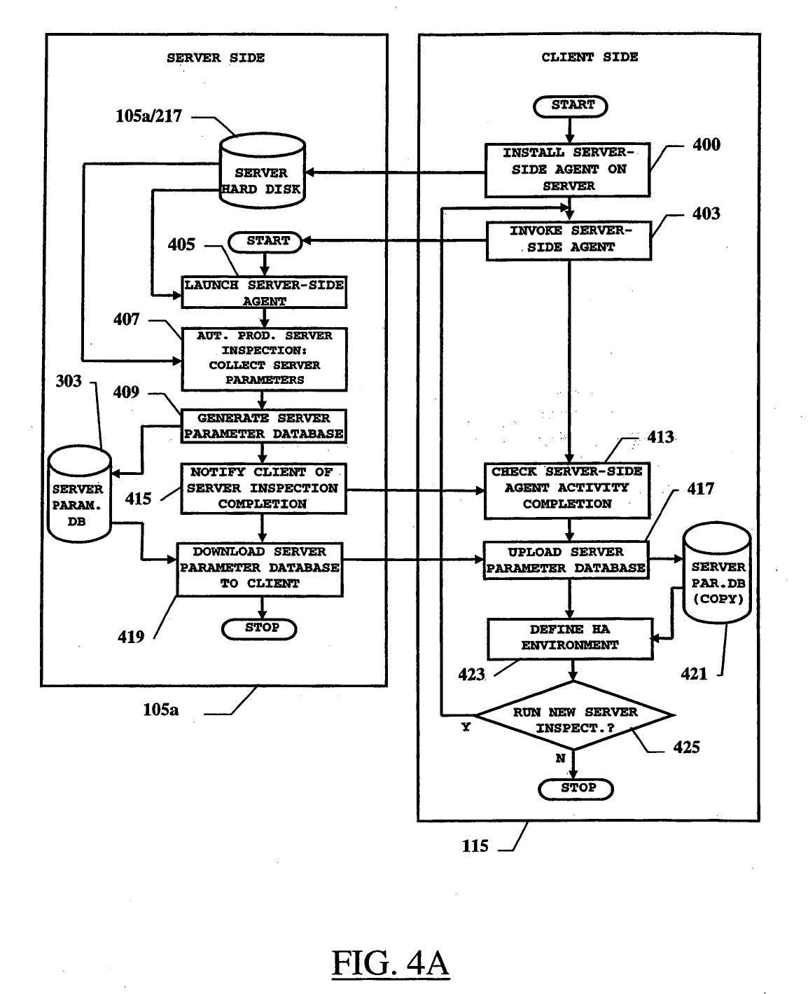

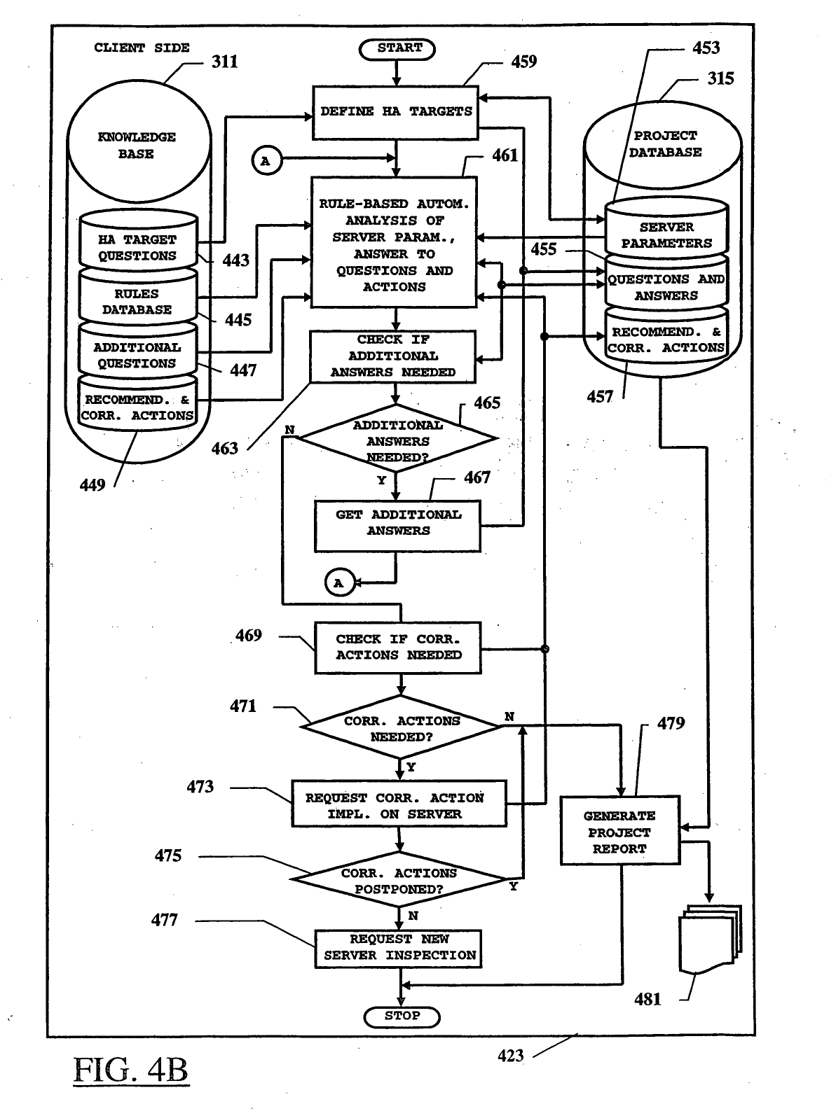

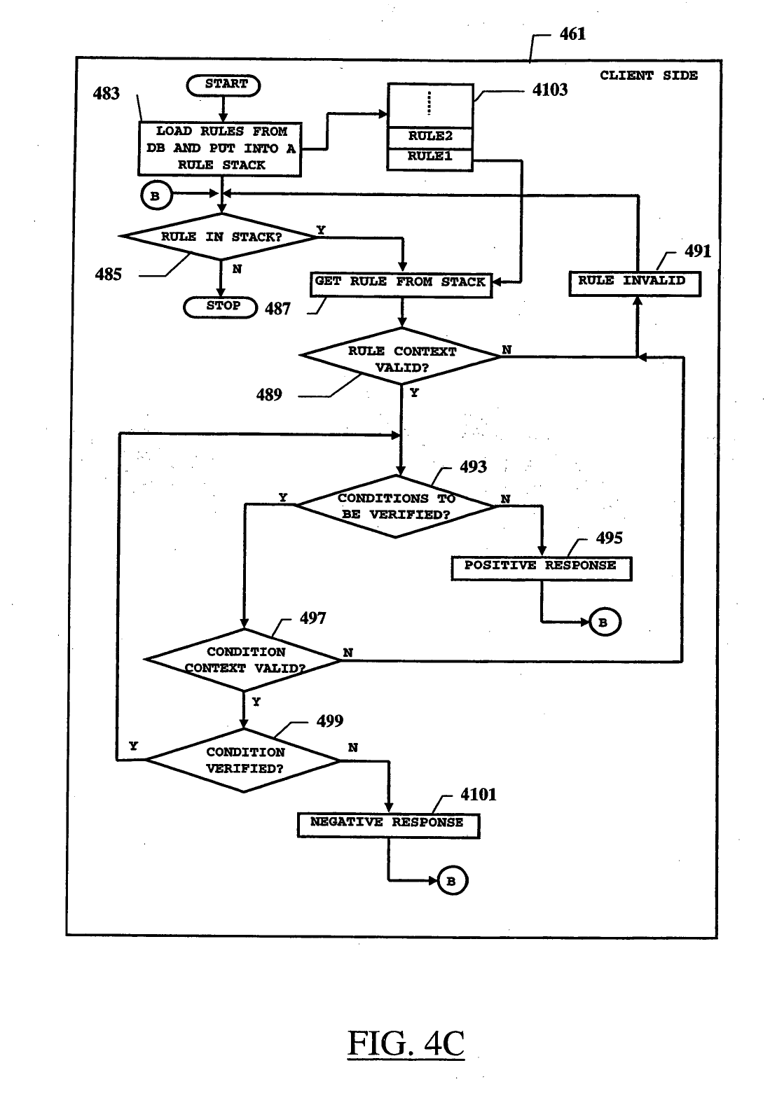

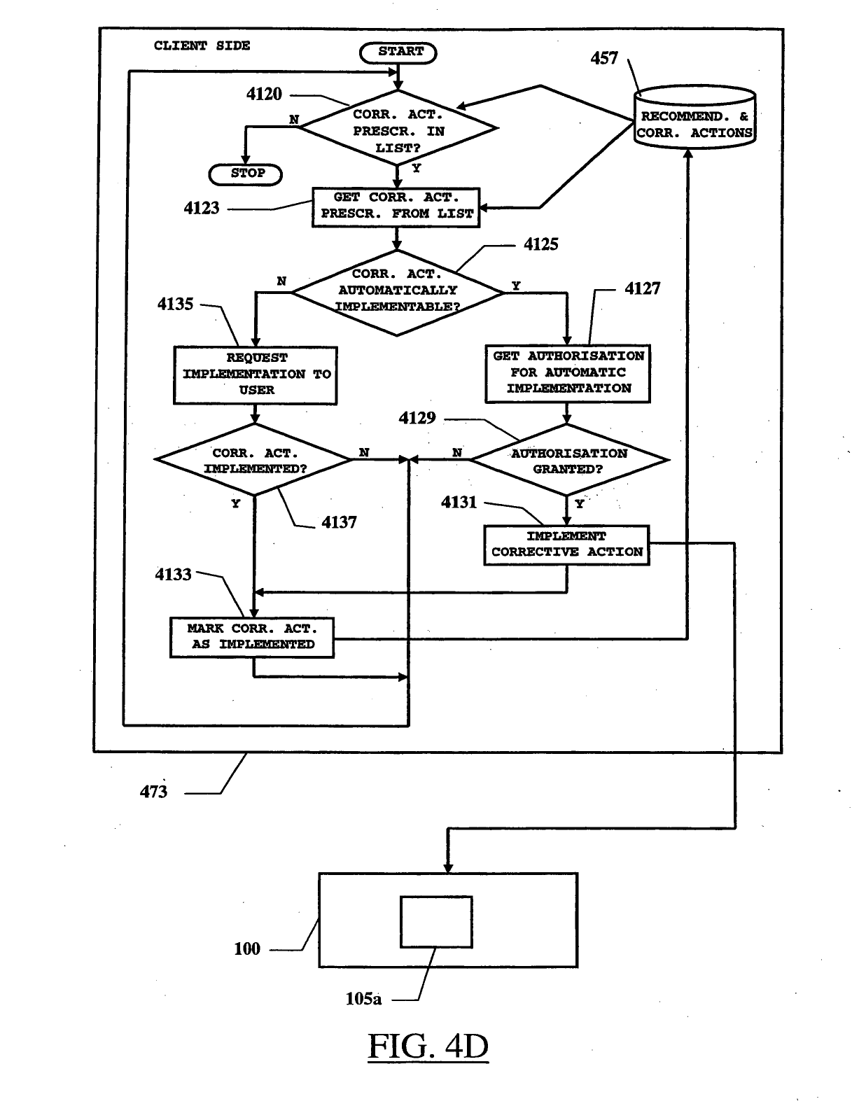

FIGS. 4A, 4B, 4C and 4D provide, in terms of schematic flowcharts, a general overview of a method according to an embodiment of the present invention. Referring to FIG. 4A, as a first step the client software component, installed and running on the client computer 115 installs the server-side software agent on the production server computer 105a (block 400). A server-side software agent installation package is uploaded and stored into hard disk 105a/217 of the production server computer 105a, and a remote installation procedure is launched by the client software component so as to cause the installation of the server-side software agent on the production server computer 105a. Alternatively, the server-side software agent can be installed on the production server computer 105a by inserting into the production server computer CD-ROM/DVD driver 105a/219 a CD-ROM/DVD with the server-side software agent installation package stored thereon; once the CD-ROM/DVD is inserted into the driver, a manual or automatic installation procedure is launched, leading to the installation of the server-side software agent; in this case, the actions schematised by block 400 are not performed by the client software component.

After the server-side software agent has been installed on the production server computer 105a, the client software component invokes the server-side software agent (block 403). The invocation of the server-side software agent by the client software component causes a production server inspection routine to be launched on the production server computer 105a. In particular, the server-side software agent 300 is launched (block 405), and an automatic exploration and inspection of the production server computer 105a is performed, particularly of the production server computer file system 317 stored on the hard disk(s) 105a/217, so as to identify and collect all production server computer parameters relevant to the definition of the HA data processing environment (block 407). Preferably, the automatic inspection of the production server computer is carried on by submitting on the production server computer 105a batch processes that do not interfere with the normal productive tasks that the production server computer 105a is intended to perform. For example, in the case the production server computer 105a is a machine of the family iSeries Servers by IBM Corporation, the automatic inspection routine is carried on by executing batch processes coded in CLP and RPG ILE language, and system Application Program Interfaces (APIs) are exploited to reduce the impact of the automatic inspection routine on the normal productive tasks.

The production server computer parameters searched for and collected by the production server computer inspection routine 407 generally vary depending in particular on the type of machine used as production server and on the type of operating system installed thereon. In the non-limiting example of a production server computer of the family iSeries Servers by IBM Corporation, the production server computer automatic inspection routine 407 allows automatically collecting the following classes of production server computer parameters:

class a) general information on the production server computer 105a, including:

a1) the name of the production server computer 105a;

a2) the type of machine used as production server computer 105a;

a3) the type and version of the Operating System (OS) installed on the production server computer 105a;

a4) the mass-storage space available on the production server computer 105a, particularly on the hard disk(s) 105a/217 thereof, and the exploited storage space;

a5) the presence or absence of a magnetic tape mass-storage unit;

a6) system values defining the behaviour of the production server computer 105a, e.g. system values defining the system auditing functionalities;

a7) network attributes of the production server computer 105a in the computer network 110, e.g. the network identifier, the local location name, the name of the network server;

class b) information on the structure of the file system of the production server computer, e.g., the list of folders and sub-folders in the file system;

class c) a list of user libraries of software objects and data available on the production server computer, and a list of the software objects contained in each user library;

class d) a list of user programs, resident on the production server computer, that exploit OS commands, particularly OS commands that are considered relevant and, possibly, critical for the definition of the HA environment.

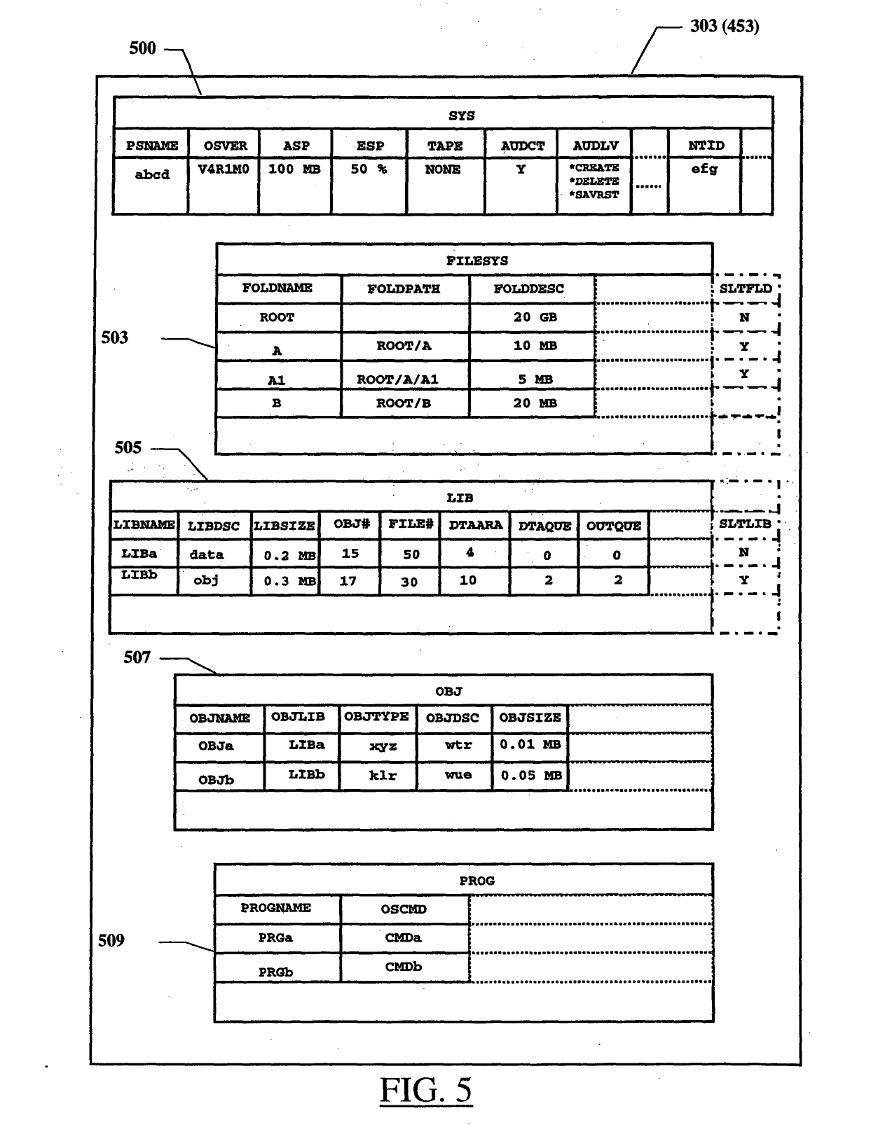

The server-side software agent 300 then generates (block 409) the server computer parameter database 303, in which the production server computer parameters, collected during the automatic production server computer inspection routine 407, are stored. It is intended that the server computer parameter database 303 may be generated during the execution of the automatic inspection routine 407, as the production server computer parameters are retrieved. The server computer parameter database 303 is preferably structured in such a way that logically coherent production server computer parameters are grouped together; referring to the above example of possible production server computer parameters collected by the production server computer inspection routine 407, the general information on the production server computer, the information on the file system structure, the list of user object libraries and the list of objects included in the libraries, and the list of user programs exploiting OS commands are stored in different files, particularly five files 500, 503, 505, 507 and 509, as schematically shown in FIG. 5.

In greater detail, the file 500, intended to store parameters of the class “general information on the production server computer” (class a in the above list), is structured as a record having a plurality of fields (e.g., the fields PSNAME, OSVER, ASP, ESP, TAPE, AUDCT, AUDLV, NTID shown in the drawing), each field intended to contain one or more respective parameters such as the name identifying the production server computer (field PSNAME), the installed OS version (field OSVER), the available storage space on the hard disk of the production server computer 105a (field ASP), the exploited storage space, e.g. in percentage of the available storage space (field ESP), the presence of a tape storage unit (field TAPE), the system values defining the production server behaviour, such as a system value defining the activation of auditing functionalities (field AUDCT) and system values or settings defining the level of auditing (field AUDLV), the network attributes of the production server computer, such as the network identifier (field NTID), and the like.

The file 503, intended to store parameters of the class “information on the file system structure of the production server computer” (class b listed above), includes a plurality of records, each one corresponding to a respective folder/sub-folder (such as the folders ROOT, A, A1, B shown in the drawing) found in the file system 317 of the production server computer 105a. Each record has a plurality of fields (e.g. the fields FOLDNAME, FOLDPATH, FOLDDESC shown in the drawing), for storing the name of the folder/sub-folder (field FOLDNAME), the folder/sub-folder path in the file system (field FOLDPATH), a description of the folder/sub-folder (field FOLDDESC) and so on. The file 505, intended to store the list of user object and data libraries found in the production server computer 105a, includes a plurality of records, each one corresponding to a respective library (e.g. the libraries LIBa and LIBb shown in the drawing); each record has a plurality of fields (e.g. the fields LIBNAME, LIBDSC, LIBSIZE, OBJ#, FILE#, DTAARA, DTAQUE, OUTQUE shown in the drawing), for storing the library name (field LIBNAME), a description of the library (field LIBDSC), the library size (field LIBSIZE), the number of software objects present in the library (field OBJ#), the number of physical files present in the library (field FILE#), the number of data areas (field DTAARA), of data queues (field DTAQUE) and of print queues (field OUTQUE) present in the library and so on.

The file 507, intended to store the list of software objects found in the production server computer 105a, includes a plurality of records, each one corresponding to a respective software object (e.g. the software objects OBJa and OBJb shown in the drawing); each record has a plurality of fields (e.g. the fields OBJNAME, OBJLIB, OBJTYPE, OBJDSC, OBJSIZE shown in the drawing) for storing the name of the respective object (field OBJNAME), the user library containing the object (field OBJLIB), the type of the object (field OBJTYPE), a description of the object (field OBJDSC), the object size (field OBJSIZE) and so on. Finally, the file 509, intended to store the list of user programs found in the production server computer 105a and exploiting OS commands, includes a plurality of records, each one corresponding to a respective user program (e.g. the user programs PRGa and PRGb shown in the drawing); each record has a plurality of fields (e.g. the fields PROGNAME and OSCMD shown in the drawing) for storing the user program name (field PROGNAME, the exploited OS command (field OSCMD) and so on.

The client software component periodically checks the execution progress status of the production server automatic inspection and server parameter database generation routines 407 and 409 (block 413). When the production server automatic inspection and server parameter database generation routines 407 and 409 are completed, the server-side software agent notifies the client software component (block 415). The client software component then activates a file transfer routine to download the server parameter database 303 from the production server computer 105a (blocks 417 and 419). A copy 421 of the server parameter database 303 is thus created locally to the client computer 115, and it is stored in the hard disk 115/217 of the client computer 115.

After the local copy 421 of the server parameter database has been created, the client software component calls a routine for the definition of the HA data processing environment (block 423); the HA data processing environment definition routine 423 will be described in detail below, in conjunction with FIG. 4B. At the exit of the HA data processing environment definition routine 423, the client software component checks whether the HA data processing environment definition routine 423 has requested a new inspection of the production server computer 105a to be carried on (block 425). In the negative case (exit branch N of block 425), the process terminates, otherwise (exit branch Y of block 425) the process flow jumps back to block 403, the server-side software agent 300 is invoked again, and all the actions previously performed are repeated. Referring now to FIG. 4B, a flowchart providing a general overview of the HA environment definition routine 423 is shown. The routine 423 works as an expert system, on the basis of the knowledge database 311; the knowledge database 311 forms the base of knowledge exploited by the HA data processing environment definition routine 423.

In particular, in an embodiment of the present invention, the knowledge database 311 is composed of four different knowledge databases 443, 445, 447 and 449. The knowledge database 443 contains a list of default or standard questions that need to be answered, by the user and/or the owner of the data processing system 100, in order to get parameters defining the targets of the HA data processing environment to be set up for the data processing system 100. The knowledge database 445 is a database of predefined rules that are exploited by the automatic analysis engine 310, invoked by the HA data processing environment definition routine 423, for automatically analysing the available parameters and configuring the data processing system 100, with the purpose of defining the HA data processing environment and preparing the data processing system 100 for the implementation of the HA data processing environment. The knowledge database 447 contains a list of additional questions that, depending on the specific situation, i.e. on the result of the automatic analysis of the available parameters, the HA data processing environment definition routine 423 may need to be answered by the user and/or the owner of the data processing system 100, for getting additional parameters necessary to define the HA data processing environment. The knowledge database 449 contains a list of recommendations/suggestions for the definition and setting up of the HA data processing environment. Additionally, the knowledge database 449 contains a list of prescriptions of corrective actions that, depending on the specific situation, it may be necessary to implement in the data processing system 100 for preparing it to the setting up the desired HA data processing environment. In an embodiment of the present invention, the knowledge databases 443, 445, 447 and 449 are structured as extensible Markup Language (XML) files.

The HA data processing environment definition routine 423, once launched, generates the project database 315. In an embodiment of the present invention, the project database 315 is composed of three project databases 453, 455 and 457. The project database 453 contains the production server computer parameters, collected by the server-side software agent 300 and downloaded by the client software component from the production server computer 105a. The project database 453 substantially coincide with the local copy 421 of the server parameter database 303, that is created locally to the client computer 115; in particular, referring to the example provided above, the project database 453 includes five files, corresponding to the five files 500, 503, 505, 507 and 509 of the server parameter database 300 shown in FIG. 5. In addition to the record fields present in the corresponding files of the server parameter database 303, some files of the project database 453 include an additional record field, for the selection of the corresponding resource for mirroring purposes (as will be better described in the following); in particular, as shown in phantom in FIG. 5, an additional record field SLTFLD in each record of the file of the project database 453 corresponding to the file 503 of the server parameter database 303, and an additional record field SLTLIB in each record of the file of the project database 453 corresponding to the file 505 of the server parameter database 303, allow storing an indication that the respective folder/sub-folder or, respectively, user library has been selected for mirroring. The project database 455 contains a list of the questions (the standard questions listed in the knowledge database 443 and, possibly, one or more of the additional questions listed in the knowledge database 447) issued during the execution of the HA data processing environment definition routine 423, together with the respective parameter/parameters derived from the answers obtained. The project database 457 contains a list of recommendations/suggestions and a list of corrective action prescriptions generated by the HA data processing environment definition routine 423.

Preferably, the project database 315 is created or saved in a project database repository (not shown), containing all the project databases of all the HA data processing environment definition projects already generated. In this case, before starting the process for analysing the data processing system 100 and defining the desired HA data processing environment, the data processing system 100 latter is defined by the user and a respective project database 315 is created within the repository. In an embodiment of the present invention, the project databases 453, 455 and 457 are DB2, Oracle or Informix relational databases, accessible through Structured Query Language (SQL) commands. Additionally, the project databases are accessible through the database connectivity module 317.

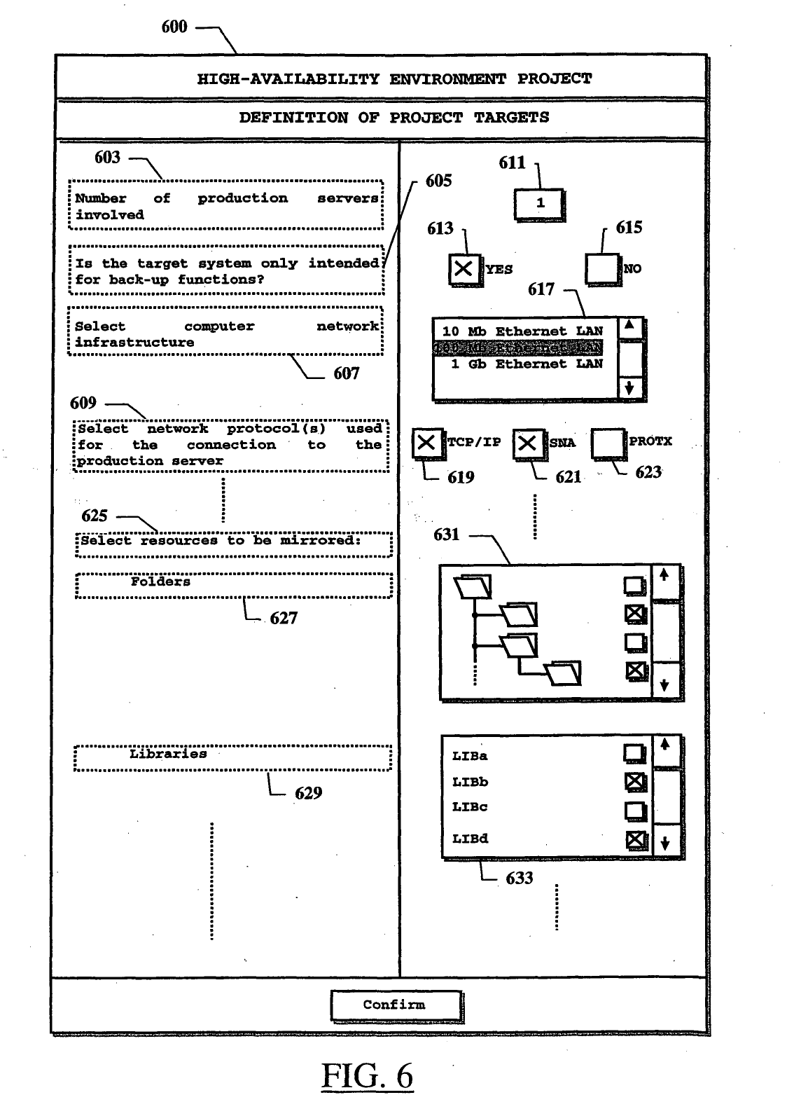

When the HA data processing environment definition routine 423 is invoked, an HA targets definition procedure is launched (block 459); during the execution of the HA targets definition procedure 459, the knowledge database 443 is accessed and the list of standard questions is retrieved. Through the GUI 313, a menu is displayed on the display device 115/211 of the client computer 115. Through the menu, the user is guided in the process of inputting the parameters necessary to define the HA data processing environment targets, possibly obtaining the necessary answers from the owner of the data processing system 100. FIG. 6 schematically shows an exemplary menu page 600; it is intended that the menu may include more than one menu page. The menu includes a plurality of text boxes 603, . . . , 609 and associated input boxes or frames 611, . . . , 623, such as check boxes and selection lists, so as to enable the user entering the information for answering the standard questions needed to define the HA data processing environment targets, using the input devices 115/213 and 115/215 of the client computer 115. Typical standard questions, which appear in descriptive form in the menu page as text boxes, may include questions on the number of production servers involved in the HA data processing environment to be set up, the functions that the back-up production server(s) 105a-bk is(are) intended to perform (merely back-up functions or additional functions), the computer network infrastructure (i.e., the type of data communication network 110), the network protocol(s) used by the production clients for communicating with the production server(s), and so on. In general, the standard questions are directed to get information relevant for the definition of the HA data processing environment, and that cannot be automatically retrieved by the automatic inspection routine 407 from the production server computer 105a.

The user, interacting if and when necessary with the owner of the data processing system 100, gets the required pieces of information and inputs them through the menu page 600. The list of standard questions and the associated answers are stored in the project database 455. In particular, as schematically depicted in FIG. 8, the project database 455 is structured as a table having an entry for each standard question got from the knowledge database 443; any entry of the table includes a first field (the field QUESTION in the drawing) in which a description of one of the standard questions get from the knowledge database 443 is stored (for example, a character string), and a second field (the field ANSWER) in which the associated parameter inputted by the user as an answer to the question is stored.

In addition to the standard questions retrieved from the knowledge database 443, the HA targets definition procedure 459 guides the user in a process of selection of the resources of the data processing system 100 intended to be rendered highly available. For example, as shown in FIG. 6, in the menu page(s) 600 text boxes 625, . . . , 629 and input boxes 631, 633 guide the user in a process of selection of the folder or folders/sub-folders, in the file system 317 of the production server computer 105a, and of the user object and data libraries resident in the production server computer 105a, that needs to be mirrored in order to implement the desired HA data processing environment. To this purpose, the project database 453 is accessed, and the data concerning the file system structure (folders/sub-folders—file FILESYS) and the libraries resident on the production server computer 105a (file LIB) are retrieved; the list of folders/sub-folders and the list of libraries are displayed on the menu page, so that the users selecting associated check boxes, can select the items that it is desired to mirror. Within the project database 453, the items selected during this process are marked as selected resources to be mirrored (record fields SLTFLD and SLTLIB in FIG. 5). Clearly, other items in addition to the folders/sub-folders and the user object and data libraries can be submitted to a selection process by the user, for example the selection may go down to the level of the single objects in the libraries.

Once the HA targets have been defined, the HA targets definition procedure 459 ends. Next, an automatic analysis procedure 461 of the available data is launched. The automatic analysis procedure 461 exploits the predefined rules in the knowledge database 445, which are applied to the data present in the project database 453 (containing the production server computer parameters automatically collected by the software-side software agent 300), in the project database 455 and in the project database 457; it is observed that at the time the automatic analysis procedure 461 is launched the first time, the project database 455 only contains the list of standard questions and associated answer parameters obtained during the execution of the HA targets definition procedure 459, and the project database 457 does not contain any recommendation/suggestion or prescription of corrective actions).

In particular, in an embodiment of the present invention the knowledge database 445 is an XML file containing all the predefined automatic analysis rules. A generic rule, when applied, can be verified or not verified, and produces as an output a response; the response may be a positive response, if the rule is verified, or a negative response, if the rule is not verified. Each rule includes one or more conditions to be verified, and the rule is considered verified, and produces a positive response, if and only if all the conditions it includes are verified; if even only one of the rule conditions is not verified, the rule is considered not verified and a negative response is produced. A generic rule condition consists of an elaborated result, a comparison operator and a reference parameter; the elaborated result is a value obtained by accessing either one of the project databases 453, 455 or 457, for example by applying an SQL command; the value retrieved from the specified project database is compared, using the specified comparison operator, to the specified reference parameter. If the comparison operator has a positive outcome, the respective rule condition is considered verified. Depending on the specific rule, the positive and negative responses of a generic rule are links to specific entries in a rule response database; the rule response database comprises the knowledge database 447, containing the list of additional questions, and the knowledge database 449, containing the list of recommendations/suggestions and prescriptions of corrective actions.

The following XML code fragment represents an exemplary rule definition:

<rule

responseCategory=“LIB”
positiveResponseKey=“”
negativeResponseKey=“key0”>

<condition

field=“DTAARA”
tables=“lib”
where=“DTAARA>0 and SLTLIB>””
regroupMethod=“*”
comparison=“>”
referenceValue=“0”

/>
<condition

field=“OSVER”
tables=“sys”
where=“OSVER=‘V5R1M0’”
regroupMethod=“*”
comparison=“>”

referenceValue=“0”
/>

</rule>

In this code fragment, key0 is the link to an entry in the rule response database that is accessed in case the application of the rule provides a negative response (negativeResponseKey=“key0”); no entry in the rule response database is specified for a positive response (positiveResponseKey=””). The exemplary rule shown includes two conditions to be verified; in particular, in this exemplary rule the two conditions require accessing the project database 453. For each condition, the file or table (lib, sys) in the project database 453 to be accessed and the respective record field (DTAARA, SLTLIB, OSVER) to be inspected are defined. Each rule condition contains one or more SQL commands or conditions (where=“DTAARA>0 and SLTLIB>””, where=“OSVER=‘V5R1M0’”), allowing to retrieve the records satisfying the SQL condition; in the shown example, all records in which the fields DTAARA and SLTLIB are not void are retrieved from the file LIB in the project database 453, and all the records in which the field OSVER contains V5R1M0 are retrieved from the file SYS of the project database 453. An aggregation method for the retrieved records is also specified (the exemplary aggregation operator regroupMethod=“*” allows counting the number of records retrieved by applying the specified SQL condition). In both of the exemplary rule conditions, the comparison operator is a simple majority operator (comparison=”>”), and the reference value is zero (referenceValue=“0”).

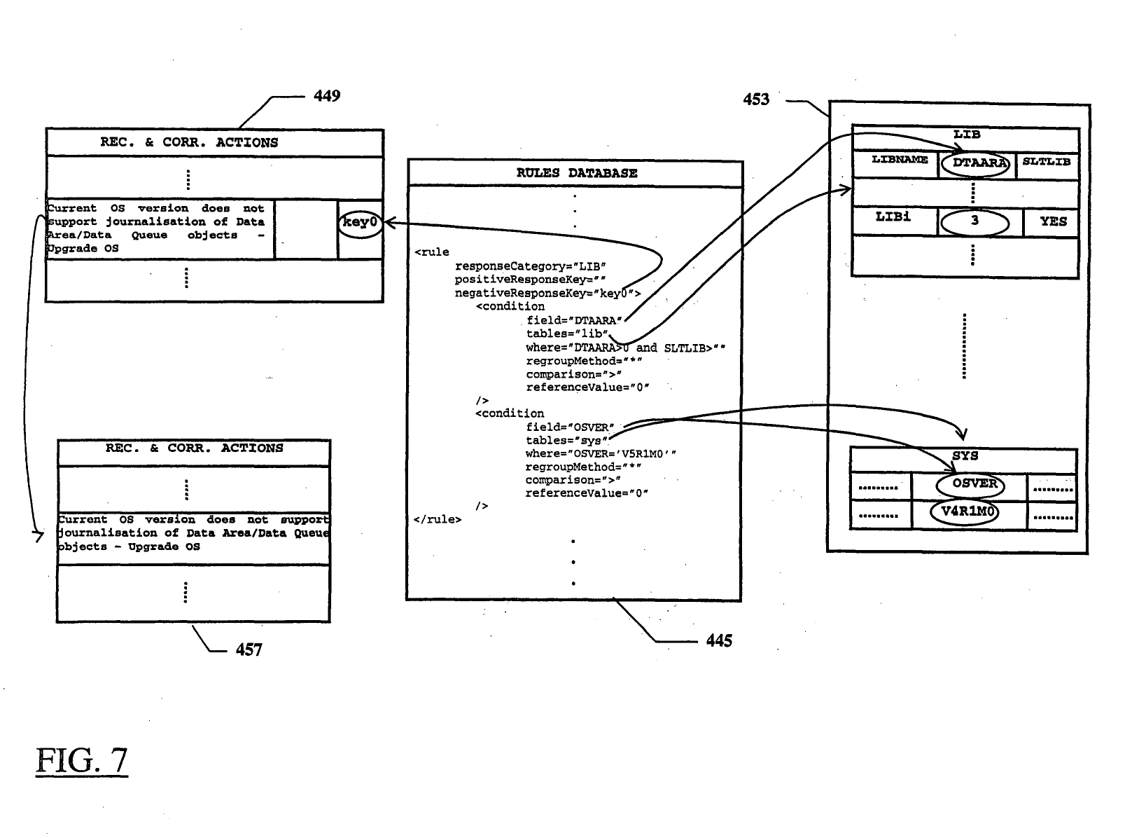

Referring to FIG. 7, when this exemplary rule is applied, the file LIB in the project database 453 is accessed, and it is ascertained whether, among the user libraries resident on the production server computer 105a, there are libraries containing data areas (field DTAARA not void), and whether such a library or libraries have been selected for mirroring during the execution of the procedure 459; as a second condition, the file SYS in the project database 453 is accessed, and it ascertained whether the operating system version (field OSVER) installed in the production server computer 105a coincides with the OS version V5R1M0. Since the second condition is not verified (the installed OS version differs from the specified version), the rule has a negative response, the entry key0 is accessed in the rule response database (in this example the knowledge database 449), and the associated prescription of corrective action:

Current OS version does not support journalising of Data Area/Data Queue objects—Upgrade OS

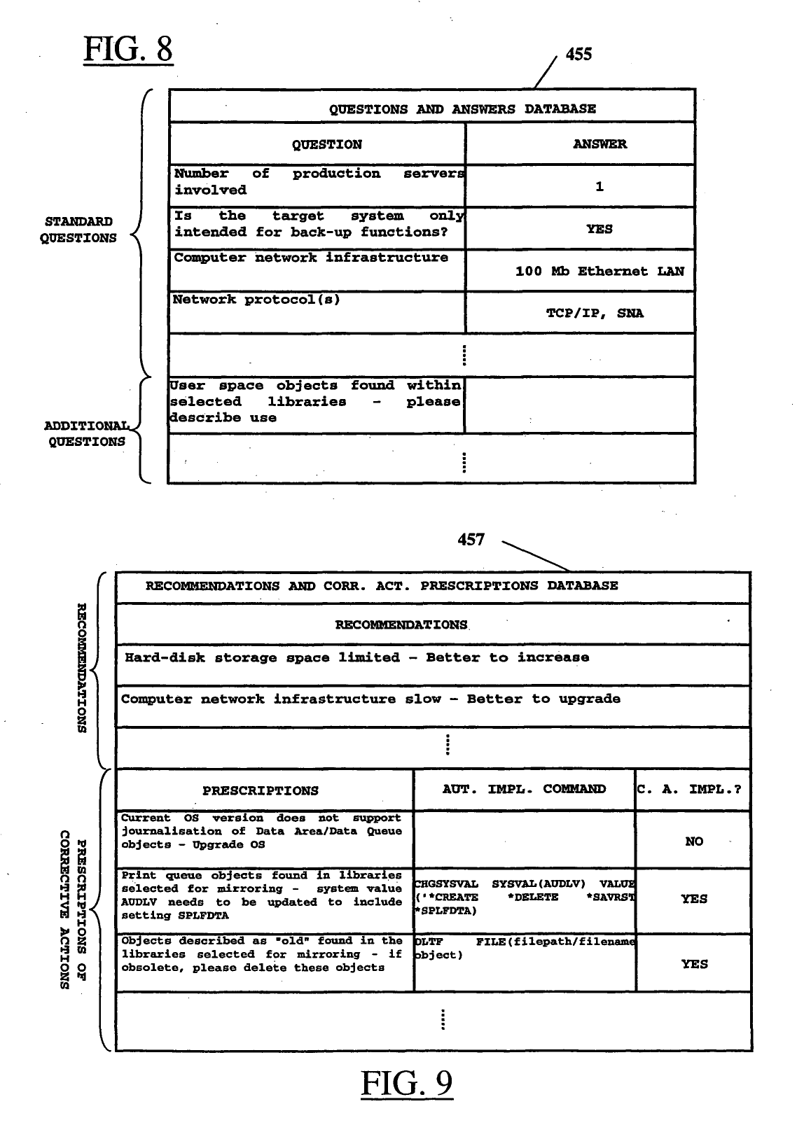

is added to the project database 457 (FIG. 9), intended to contain the list of recommendations/suggestions and prescription of corrective actions.

The flowchart of FIG. 4C provides a general overview of the rule-based automatic analysis procedure 461. The automatic analysis engine 310 is launched. As a first step, the knowledge database 445 is accessed, all the rules are retrieved and they are put into a rule stack 4103 (block 483). Then, it is checked whether there are rules in the rule stack 4103 (block 485) to be applied. If there are rules in the stack (block 485, exit branch Y), the first rule in the stack is taken from the rule stack 4103, for example on a first-in first-out basis, and the rule is applied (block 487). The validity of the rule context is first ascertained (block 489): in particular, the correctness of the rule sintax, and the existence of the rule positive and negative responses are verified. If it is ascertained that the rule context is not valid (block 489, exit branch N), the rule is declared as invalid (block 491), no response is produced, and the next rule is taken from the rule stack 4103 (block 487). If instead the rule context is ascertained to be valid (block 489, exit branch Y), it is ascertained whether the current rule includes conditions still to be verified (block 493). In the negative case (block 493, exit branch N), a positive response is declared for the rule (block 495), the proper response is taken from the response database (accessing the proper knowledge database among the knowledge databases 447 and 449) and the next rule is taken from the rule stack 4103 (connector B). Otherwise (block 493, exit branch Y), it is ascertained whether the condition context, i.e. the formal correctness of the rule conditions, is valid (block 497). If the condition context is found invalid (block 497, exit branch N), the rule is declared invalid (block 491), no response is produced, and the next rule is taken from the rule stack 4103. If the condition context is found valid (block 497, exit branch Y), the rule condition is applied and it is ascertained if the condition is verified (block 499). In the affirmative case (block 499, exit branch Y), the next rule condition is assessed, otherwise (block 499, exit branch N) the rule is declared to have a negative response (block 4101), the proper response is taken from the response database and the next rule is taken from the rule stack 4103 (connector B). When no more rules are left in the stack (block 485, exit branch N), the automatic analysis procedure 461 terminates.

It can be appreciated that the application of the predefined automatic analysis rules may cause the knowledge database 447 to be accessed one or more times, and one or more additional questions to be selected from the additional question list of the knowledge database 447 and be added to the project database 455; similarly, the project database 449 may be accessed one or more times, and one or more recommendations/suggestions and/or prescriptions of corrective actions be selected from the lists of the knowledge database 449 and be added to the project database 457.

It should be noted that some analysis steps of the automatic analysis procedure, instead of being based on the predefined rules in the knowledge database 445, may be directly embedded in the code of the automatic analysis procedure 461. Once the automatic analysis procedure 461 has applied all the predefined rules present in the knowledge database 445, the project database 455 is accessed to check whether, during the execution of the automatic analysis procedure 461, additional questions have been added to the existing list of questions and associated answers (blocks 463 and 465). In the affirmative case, a procedure 467 is activated for having the user get the information answering the additional questions. Similarly to the HA targets definition procedure 459, the project database 455 is accessed and the additional questions are retrieved; one or more menu pages are displayed, through the GUI 313, on the display device 115/211 of the client computer 115, with text boxes providing the additional questions in descriptive form, and the user is guided in the process of entering, through input boxes in the menu page or pages, the required additional information.

The answer parameters obtained during the execution of the procedure 467 are stored in the project database 455; in particular, as schematically depicted in FIG. 8 and similarly to the standard questions, for each additional question selected from the knowledge database 447 during the execution of the automatic analysis procedure 461, a new entry is created in the table of the project database 455; such an entry contains a first field, with a description of the additional question, and a second field with the corresponding answer obtained during the execution of the procedure 467.

Once the additional questions have been answered, the procedure 467 ends, and the flow jumps back to the automatic analysis procedure 461 (connector A). The automatic analysis procedure 461 is launched again, and a new automatic analysis is performed. In this way, those rules that could not be applied in the previous run of the automatic analysis procedure 461, because they included conditions that necessitated parameters obtained by answering the additional questions, can now be applied. It is observed that new additional questions can be added to the project database 455 during the new run of the automatic analysis procedure 461, so that the process can be reiterated a number of times. If instead no additional questions are found in the project database 455, the project database 457 is accessed to ascertain whether one or more prescriptions of corrective actions have been generated during the execution of the automatic analysis procedure 461 (blocks 469 and 471).

In the affirmative case (block 471, exit branch Y), a procedure is launched requesting the user to implement the necessary corrective actions, retrieved from the project database 457 (block 473). Through the GUI 313, one or more menu pages are displayed on the display device 115/211 of the client computer 115. The menu page or pages include text windows, wherein a human-readable description of the required corrective actions needing to be implemented on the data processing system 100 is displayed, and associated input boxes, which the user can activate to declare that the required corrective actions have been or will be implemented. The user is left free to either implement none, some or all of the required corrective actions at this time, before the HA data processing environment definition procedure goes on, or to implement them at a later time.

In an embodiment of the present invention, one or more of the prescribed corrective actions, once authorized by the user, are automatically implemented on the data processing system 100, particularly on the production server computer 105a. In the following, two possible corrective actions that can be automatically implemented by the HA definition software tool will be described, assuming again by way of example that the production server computer 105a is a machine of the family iSeries Servers by IBM Corporation. As a first example, let the following rule definition (in XML language) be considered:

<rule

responseCategory=“LIB”
positiveResponseKey=“outqnoaudlvl”
negativeResponseKey=“”>

<condition

field=“OUTQ”
tables=“lib”
where=“OUTQUE>0 and SLTLIB>””
regroupMethod=“*”
comparison=“>”
referenceValue=“0”

/>
<condition

field=“AUDLV”
tables=“sys”
where=“AUDLV NOT LIKE ‘%*SPLFDTA%”
regroupMethod=“*”
comparison=“>”

referenceValue=“0”
/>

</rule>

The rule has a positive result if, among the libraries selected for mirroring, there is one or more libraries containing print queues (field OUTQUE in the file LIB not equal to 0) and at the same time the settings of the system value specifying the level of auditing functionalities of the production server computer 105a (field AUDLV in the file SYS) does not include the setting SPLFDTA (a setting enabling auditing of spooled file functions). In case the application of this rule provides a positive result, the following descriptive prescription of corrective action is taken from the knowledge database 449 and is added to the project database 457:

Print queue objects found in libraries selected for mirroring —system value AUDLV needs to be updated to include setting SPLFDTA.

If the user (preferably after having informed and obtained authorization from the owner of the data processing system 100) grants the authorization for automatically implementing the proposed corrective action, the following system command (stored in the knowledge database 449 together with the corresponding descriptive description of corrective action) is issued by the HA definition software tool to the production server computer 105a:

CHGSYSVAL SYSVAL(AUDLV) VALUE (‘*CREATE *DELETE *SAVRST *SPLFDTA)

where CREATE, DELETE and SAVRST represent exemplary current settings of the system value AUDLV in the production server computer 105a, before the corrective action is implemented. As a consequence of the application of this system command to the production server computer 105a, the settings of the system value AUDLV are updated to include the desired setting SPLFDTA.

As a second example, let the following rule definition (in XML language) be considered:

<rule

responseCategory=“LIB”
positiveResponseKey=“oldobj”
negativeResponseKey=“”>

<condition

field=“OBJDSC”
tables=“obj”
where=“OBJDSC LIKE ‘%old%”
regroupMethod=“*”
comparison=“>”

referenceValue=“0”
/>

</rule>

This second exemplary rule provides a positive response if there are objects containing in the field OBJDSC the character string old, possibly meaning that such objects are obsolete and can be canceled (preferably, the rule will include conditions, not explicitly shown, directed to limiting the check to the objects belonging to libraries selected for mirroring). In case the application of this rule provides a positive result, the following descriptive prescription of corrective action is taken from the knowledge database 449 and is added to the project database 457:

Objects described as “old” found in the libraries selected for mirroring—if obsolete, please delete these objects.

If the user grants the authorization for automatically implementing the proposed corrective action, the following system command or commands are issued by the HA definition software tool to the production server computer 105a:

DLTF FILE(filepath/filename object)

where filepath/file object means the path and file name of the object file to be deleted. In other words, and in general terms, in the knowledge database 449 containing the list of recommendations and the list of prescriptions of corrective actions, one or more prescriptions of corrective actions are accompanied by commands that, if the automatic implementation of the corresponding corrective actions is authorized by the user, can be automatically issued by the HA definition software tool to the data processing system 100, in order to automatically implement the corresponding corrective actions. The commands stored in the knowledge database may be command templates, which are completed by parameters retrieved from the project database 451, particularly from the project database 453 (as in the case of the two exemplary rules provided before). In general, only some corrective actions are of such a nature that automatic implementation thereof is possible; the implementation of other corrective actions, such as increasing the hard disk(s) storage space of the production server computer 105a or upgrading the OS version, is left to the user.

FIG. 4D is a schematic flowchart providing an overview of the procedure 473 requesting the user to implement the corrective actions, in an embodiment of the present invention. The presence of prescription of corrective actions in the project database 457 is first checked (block 4120). In the negative case (block 4120, exit branch N) the procedure ends, otherwise (exit branch Y) the first corrective action prescription is retrieved from the project database, for example on a first-in, first-out basis (block 4123). Then, it is ascertained whether the corrective action can be automatically implemented (block 4125); this can for example rely on the presence in the project database 457 of commands associated with the proposed corrective action. In the affirmative case (block 4125, exit branch Y), authorization is requested to the user for automatically implementing the corrective action (block 4127); for example, through the GUI 313, a menu page similar to that shown in FIG. 6 is displayed to the user on the display 115/211 of the client computer 115; the prescription of corrective action is displayed in descriptive form, possibly together with the command or commands proposed for automatically implementing the corrective action; through a check box, the user can select whether or not to grant the authorization for automatically implementing the corrective action. Preferably, before deciding whether to implement a corrective action, the user shall get the authorization by the owner of the data processing system 100. If the authorization is granted (block 4129, exit branch Y), the HA definition software tool automatically implement the corrective action on the data processing system, for example by issuing the predefined system command or commands described in the foregoing to the production server computer 105a (block 4131); it is observed that this may imply that the client computer 115 connects to the production server computer 105a (or to a network server computer) with system manager privileges, and issues remote system commands. The corrective action is then marked as implemented in the project database 457 (block 4133). If on the contrary the authorization is not granted (block 4129, exit branch N), no action is undertaken, and the flow loops back to block 4120. In case the corrective action is one that cannot be automatically implemented (for example, a corrective action involving updating the version of the OS installed on the production server computer 105a), the user is requested to implement the corrective action (block 4135); for example, through the GUI 313, a menu page is displayed in which a description of the proposed corrective action is shown. The user is left free to take the necessary steps for implementing the corrective action at this time or at a later time; in case the user decides to implement the corrective action at this time, the user selects the corrective action through a check box. If the corrective action is detected as implemented at this time (block 4137, exit branch Y), the corrective action is marked as implemented in the project database 457 (block 4133). The flow loops back to block 4120, and all the above described actions are repeated until all the prescriptions of corrective actions in the project database 457 are checked.

Referring again to FIG. 4B, in the case at least one of the prescribed corrective actions is implemented during the procedure 473, either by the user or automatically by the HA definition software tool, on the data processing system 100 at this time (block 475, exit branch N), a new inspection of the production server computer 105a is normally needed. The HA environment definition routine 423 terminates returning an output code corresponding to a request of a new inspection of the production server computer 105a (block 477).

In practice, it may happen that some corrective actions, albeit implemented at this time on the data processing system 100, either by the user or automatically, are of such a nature that a new inspection of the data processing system 100 is not necessary. In this case, no request is made of a new production server computer inspection.

In case all the required corrective actions are postponed (block 475, exit branch Y), or if no prescriptions of corrective actions are found in the project database 457, a procedure is launched for generating a project report (block 479). The project databases 453, 455 and 457 are accessed, the data stored therein are retrieved and they are merged to generate an output report 481. The output report 481 includes the production server computer parameters, retrieved by the automatic inspection routine 407 from the production server 105a, the list of standard and, if any, additional questions generated during the execution of the procedures 459 and 461, and the associated answers obtained, the list of recommendations/suggestions and the list of corrective action prescriptions, with associated indications of whether the corrective actions have been implemented.

The output report 481 includes a human-readable output report, for example formatted in HTML, that provides to the user all the necessary information on the data processing system 100, and all the indications, prescriptions of corrective actions and/or recommendations/suggestions necessary for implementing the desired HA data processing environment in the data processing system 100. For the generation of the human-readable output report, a report template is exploited. The report template is for example an HTML file, containing predefined tags; the project report generation procedure 479 substitutes every tag in the report template with a corresponding project parameter, extracted from the project database 315. The human-readable output report provides to an HA expert all the information necessary for setting up the desired HA data processing environment in the data processing system 100. In particular, the human-readable output report contains detailed information on which corrective actions have already been implemented during the HA data processing environment definition phase, either by the user or automatically, and which corrective actions are instead still to be implemented.

In addition to the human-readable output report, a machine-readable output report may be generated, for example formatted in XML language. The machine-readable output report can be exploited by a software tool for automatically implementing the HA data processing environment. For example, on the basis of the output report, the HA implementing software tool can automatically generate resource groups or clusters, by means of an automatic “collocation” process (in jargon, a process involving establishing binary links between the resources in the group) and mirror the generated resource group clusters into the back-up production server 105a-bk.

Thus, according to the present invention, the process of analysing and configuring an existing data processing system for HA is substantially error-free and fast and does not require a highly skilled systems analyst.

What is claimed is:

1. A method for configuring a data processing system for high availability, said method comprising the steps of:
defining a set of rules for high availability;
defining a set of target parameters indicative of a target configuration of said data processing system which is highly available;
automatically collecting from said data processing system a set of existing parameters indicative of a current configuration of said data processing system; and
automatically applying said rules with said target parameters to said existing parameters to identify actions to reconfigure said data processing system for high availability.

2. The method of claim 1 wherein said target parameters identify resources of said data processing system intended to be highly available.

3. The method of claim 2 wherein said step of defining said target parameters comprises the step of automatically querying a user to input said target parameters.

4. The method of claim 1 wherein one of said target parameters is an identification of a library that should be mirrored.

5. The method of claim 4 wherein said rules comprise a rule that a print queue of said library should be audited.

6. The method of claim 4 wherein said rules comprise a rule that objects which reside in said library and marked as old or obsolete should be deleted.

7. The method of claim 4 wherein said rules comprise a rule that an operating system within said data processing system should support journalizing of said library.

8. The method of claim 7 wherein the identified action when said operating system does not support journalizing of said library is to upgrade to another operating system that supports said journalizing.

9. The method of claim 6 further comprising the subsequent step of automatically deleting said objects marked as old or obsolete.

10. The method of claim 1 further comprising the subsequent step of a user implementing the identified actions.

11. The method of claim 1 further comprising the subsequent step of automatically implementing one or more of the identified actions.

12. A computer program product for configuring a server computer for high availability, said computer program product comprising:
a computer readable medium;
first program instructions, executable at a client computer, for querying a user to define a set of rules for high availability;
second program instructions, executable at said client computer, for querying a user to define a set of target parameters indicative of a target configuration of said server computer which is highly available;
third program instructions, executable at said server computer, for automatically collecting from said server computer a set of existing parameters indicative of a current configuration of said server computer; and
fourth program instructions, executable at said client computer, for automatically applying said rules with said target parameters to said existing parameters to identify actions to reconfigure said server computer for high availability; and wherein
said first, second, third and fourth program instructions are recorded on said medium.

13. A computer program product as set forth in claim 12 further comprising fifth program instructions, executable at said server computer, for transferring said set of existing parameters to said client computer, and wherein said fifth program instructions are recorded on said medium.

14. A computer program product as set forth in claim 12 wherein said target parameters identify resources of said server computer intended to be highly available.

15. A computer program product as set forth in claim 12 wherein said second program instructions automatically query a user to input said target parameters.

16. A computer program product as set forth in claim 12 wherein one of said target parameters is an identification of a library that should be mirrored.

17. A system for configuring a server computer for high availability, said system comprising:
a client computer including means for querying a user to define a set of rules for high availability, and means for querying a user to define a set of target parameters indicative of a target configuration of said server computer which is highly available; and wherein
said server computer includes means for automatically collecting from said server computer a set of existing parameters indicative of a current configuration of said server computer; and wherein
said client computer also includes means for automatically applying said rules with said target parameters to said existing parameters to identify actions to reconfigure said server computer for high availability.

18. A system as set forth in claim 17 wherein said server computer further includes means for transferring said set of existing parameters to said client computer.
